(19) United States
(12) Patent Application Publication
(10) Pub. No.: US 2004/0209777 A1
(43) Pub. Date: Oct. 21, 2004

(54) Agents for improving the qualities of fruits/grains

(76) Inventors: Hiroshi Gemma, Tsukuba-shi (JP); Masahiko Kuraichi, Tokyo (JP); Makoto Takeuchi, Kawasaki-shi (JP)

Correspondence Address: OBLON, SPIVAK, MCCLELLAND, MAIER & NEUSTADT, P.C., 1940 DUKE STREET, ALEXANDRIA, VA, 22314, US

(21) Appl. No.: 10/484,802

(22) PCT Filed: Aug. 1, 2002
(86) PCT No.: PCT/JP02/07831

(30) Foreign Application Priority Data
Aug. 2, 2001 (JP) 2001-235266

(51) Int. Cl. A01N 43/36

(52) U.S. Cl. 504/283

(57) ABSTRACT

In this application are disclosed a fruit- or berry-quality improving agent containing proline as the effective ingredient, which agent is in the form of an aqueous solution of proline with a 50% or higher purity and having a concentration ranging from 15 to 1,500 ppm in terms of the proline, and a method of improving fruits or berries in quality which method comprises spraying an aqueous solution of proline with a 50% or higher purity and having a concentration ranging from 15 to 1,500 ppm in terms of the proline onto the leaf surfaces of a fruiting plant at the fruit or berry growing period or over the period between the flower-bud formation period or before and the fruit or berry growing period. According to the present invention are provided an excellent agent for improving fruits or berries in quality and a method of improving fruits or berries in quality with the use of the same.

### TECHNICAL FIELD

The present invention relates to a fruit-quality or berry-quality improving agent for fruiting plants, more particularly to a fruit- or berry-quality improving agent for a fruit tree or a fruit vegetable comprising, as the effective ingredient, proline which is effective for improving or breeding fruits or berries in respect of enlargement, aroma, flavor, taste, palate feeling, and the like, of fruits produced by fruit trees such as pear, apple, peach, cherry fruit, grape, and the like, or berries produced by fruit vegetables such as strawberry, tomato, melon, and the like.

### BACKGROUND ART

Some examples using an amino acid-related substance for plants have been so far known.

For example, in (a) Japanese Published Examined Patent Application (Kokai) No. 1971-42566 is disclosed a flower initiation promoting agent containing at least one of uracil and cytosine among nucleic acid bases, and proline. In this Japanese Published Examined Patent Application No. 1971-42566, it is described that a combined use of uracil and proline for flowering plants, vegetables, fruit trees or the like realizes effects of flower-bud formation promotion, growth promotion, fruit enlargement, increase of flower setting number, and the like. In addition, in Japanese Published Unexamined Patent Application (Kokai) No. 1988-45211 is disclosed a plant growth promoting agent prepared by compounding additionally glutamic acid or a salt thereof with uracil and proline. Such effects as elongation promotion, yield increase, improvement in leaf color, and improvement in tree force, of the crops, are mentioned as those realized by compounding glutamic acid or a salt thereof with uracil and proline.

In (b) Japanese Published Unexamined Patent Application (Kokai) No. 1973-67051 is disclosed a fruiting and fruit enlargement promoting agent containing at least one of nucleosides and nucleotides and proline. I.e., it is described therein that “proline mentioned herein includes proline itself, of course, and also a hydrolysate of a protein or an amino acid mixture, which contains proline. The nucleosides refer to those containing mainly one or two or more of adenosine, guanosine, cytidine, uridine and thymidine, and may be added with various high polymer nucleic acids or a hydrolysate thereof. The nucleotides refer to those containing mainly one or two or more of adenylic acid, guanylic acid, cytidylic acid, uridylic acid, thymidylic acid and an ammonium salt or sodium salt thereof, of which the pH has been adjusted to 7.0, and may be added with various high polymer nucleic acids or a hydrolysate thereof”. Incidentally, the composition (weight ratios) of the fruiting and fruit-enlarging promoting agent used in the examples of the Kokai document is as follows: 5 parts of proline, 1 part of glutamic acid, 1 part of naturally-occurring protein hydrolysate, 1 part of adenosine, 5 part of uridine, and 1 part of a naturally-occurring high polymer nucleic acid hydrolysate.

In (c) Japanese Published Unexamined Patent Application (Kokai) No. 1974-91829 is disclosed “a method for improving the quality of citrus fruits, by applying a solution, which contains one or 2 or more amino acids selected from arginine, proline, γ-aminobutyric acid, ornithine, glycine, valine, leucine, isoleucine, glutamic acid, aspartic acid, lysine, and hydroxyproline, onto the surfaces of leaves and (or) surfaces of fruits of a citrus tree within the growth period of the fruits thereof”.

And, it is described therein that “the effective amino acids usable according to the present invention are restricted to the above-mentioned 12 amino acids. As solutions containing one or 2 or more of these specific amino acids, there may be mentioned those containing a pure product of these amino acids, of course, those containing these amino acids, crude solutions, as usable similarly, containing these amino acids, e.g., a solution obtained by decomposing the protein of soy beans, cereals, microorganism cells, and the like in various ways, an amino acid-fermented solution, and the like. The amino acids-containing solutions according to the present invention include these crude solutions. The amino acid solutions to be used according to the invention can normally be in the form of an aqueous solution, and however, may be appropriately in the form of a solution harmless for citrus fruit trees”. In addition, it is also described therein that-“the amino acid-containing solutions to be used according to the present invention may have any concentration without particular restriction, and those having a concentration range from 0.01 to 0.6% are, in general, preferably used”. This means that a preferable concentration ranges from 100 to 6,000 ppm.

Incidentally, it is described therein that “the taste is one of the important quality factors to determine the commercial value of Satsuma mandarin, Citrus natsudaidai, Citrus hassaku, oranges, grapefruit, Iyokan orange, a close relative of Pummelo or Citrus grandis, and the like. Traditionally, those having a suitable sweetness-sourness balance, i.e., those with a weak proper sourness and strong sweetness (high sugar concentration) are highly evaluated as of a high quality. An ideal quality includes near 10.0 of a sweetness ratio (sugar weight content/acid weight) as an index of the proper sweetness-sourness balance, 10 to 14% of the sugar content and 1.0 to 1.2% of the acid content”.

In (d) Japanese Published Unexamined Patent Application (Kokai) No. 1987-246891 is disclosed “a fertilizer containing one or more chemical compounds selected from the group consisting of proline, cytosine, uracil, the nucleoside of cytosine, the nucleotide of cytosine, the nucleoside of uracil and the nucleotide of uracil, and a hydrolysate of the bacterial cells of a photosynthetic bacterium”. The document states that “it has been recognized that the fertilizer has a fruit enlargement action in addition to a flower-bud formation promoting action”.

(e) Japanese Published Unexamined Patent Application (Kokai) No. 1994-125655 discloses that it is an object “to provide a coloration promoting agent of fruits and a method of its use, which yield a produce of an economically low price and a good taste” that “making an oleophilic carotene to be water-soluble, followed by mixing with amino acids, nucleic acids, vitamins, auxins, cytokinine (kinetin) oligo, or the like,” as the constitution of the invention concerned,” results in an synergistic effect and a physiological action of the kinetin, auxins and amino acids, in addition to the β-carotene component, whereby such excellent results as pigment production promotion, enlargement, sugar content increase and the like, of the fruits, are caused. Methods for its use includes watering onto the roots or spraying onto the leaf surfaces, of a fruit tree, whereby the pigment production promotion, enlargement, sugar content increase and the like, of fruits, are simultaneously effected by an enhanced plant biosynthesis, with a 20 to 30% increment of the yield, at an economically lower price”.

In (f) Japanese Published Unexamined Patent Application (Kokai) No. 1998-279405 is disclosed a preventing method of pine trees from dying down, which comprises spraying a plant activating agent mainly composed of proline, together with an alkaline ionic water on the ground parts of pine trees and/or watering the acidic ionic water to the underground parts of pine trees.

In (g) Japanese Published Unexamined Patent Application (Kokai) No. 1988-45211 is disclosed a yield-increasing method for cereal crops, fruit vegetables, root vegetables, flowering plants, fruit trees, or the like, which method comprises applying a yeast extract containing 10 to 40% of ribonucleic acid or a decomposition product of ribonucleic acid and added with proline or uracil, each in an amount of 0.5 to 20%, as the fertilizer, to the cereal crops between periods of about juvenile ear formation and earing up, or to fruit vegetables, root vegetables, flowering plants, fruit trees or the like. In the document, the target crops include Gramineae plants such as rice, wheat, corn, and the like, and also fruit trees such as pear, peach, grape, and the like, and the effects include enhancing effects such as flowering, flower setting, fruit enlargement, and the like. In addition, it is described therein that proline and uracil can be a flower-bud formation promoting agent in the prior art.

### DISCLOSURE OF THE INVENTION

In the background described above under the preceding “Background art” section, it is an object of the present invention to provide an excellent quality-improving agent for fruits and berries, and a method of improving fruits and berries in quality employing the improving agent.

The present inventors have intensively carried out a research to achieve the object as mentioned above and found that spraying proline of a high purity onto leaf surfaces causes improved quality to the fruits and berries. On the basis of these findings, they have completed the present invention.

Accordingly, the present invention relates to a fruit- and berry-quality improving agent containing proline as the effective ingredient, which agent is in the form of an aqueous solution of proline with a 50% or higher purity and having a concentration ranging from 15 to 1,500 ppm in terms of the proline, and a method of improving fruits and berries in quality which method comprises spraying an aqueous solution of proline with a 50% or higher purity and having a concentration ranging from 15 to 1,500 ppm in terms of the proline onto the leaf surfaces of a fruiting plant at the fruit or berry growing period or over the period between the flower-bud formation period or before and the fruit or berry growing period.

Hereafter, the present invention will be described in detail.

Quality improvement of fruits or berries, according to the present invention, means making better the taste (aroma, sugar content, hue, hardness, and the like) of fruits or berries. For example, in the case of pears, in addition to fruit enlargement so far known, it means strengthening sweetness by increasing the sugar content and enforcing the aroma whereby the fruits are made sweet and excellent in taste. In general, it is pointed out as an accepted opinion regarding the relation between the size and the quality of fruits that increased size of fruits inversely decreases their quality. However, this accepted opinion is not applicable to the present invention. I.e., according to the present invention, a combined effect can be realized of increasing the size of fruits and improving the quality thereof as well.

In the case where the method of the present invention is applied to grape trees, improvements can be realized in the sugar content and the coloration such as red or the like of grape fruits. For a cultivar showing coloration of a pericarp, such as Kyohou grape, fruits with a stronger coloration are generally evaluated and, thus, applying the method of the present invention enables to harvest grape fruits having an enhanced coloration and therefore, a higher commercial value. This, i.e., the effect of enhancing coloration of grape fruits plays an important role in cultivation of grape cultivars for red wine. In recent years, it is pointed out as a problem that in red wine manufacture, environmental changes such as global warming influence red color of red wine to become thinner resulting in the lowered commercial value. Applying the present invention is expected to be capable of solving this problem.

Target plants, to which the inventive fruit- and berry-quality improving agent and the inventive method of improving qualities of fruits or berries are to be applied, are not particularly restricted and include plants of Rosaceae, Vitaceae, Cucurbitaceae, Solanaceae, Rutaceae, Ebenaceae, Leguminosae, Gramineae, Malvaceae, and the like, and specifically, fruiting plants such as fruit trees, e.g., pear, apple, peach, cherry fruit, grape, and the like, and fruiting vegetables, e.g., strawberry, tomato, melon and the like. Inter alia, the good effect appears particularly in Rosaceae (pear, apple, plum, peach, cherry fruit, ume (Japanese apricot), strawberry and the like) and Vitaceae (grape). These species of fruit trees and fruiting vegetables produce fruits and berries of a good quality by applying the method of the present invention.

Proline to be used for the present invention is the L-isomer (L-Pro) in consideration of its suitability to the plant body. The purity thereof is 50% or higher, preferably as high as 70% or higher, and more preferably as high as 90% or higher. The reason why such high purity is necessary is because such disturbance as salt injury or the like caused by the impurities must be avoided and the effect of proline must be prominently expressed. In this connection, the purity of proline according to the present invention is a proportion of the proline to the total solid content contained in the aqueous proline solution as the fruit- and berry-quality improving agent according to the present invention. And, the percents (%'s) in this specification mean %'s by weight.

Such high purity proline is preferably prepared in the form of an aqueous solution and applied to fruiting plants in this form. Upon application, the concentration thereof ranges from 15 to 1, 500 ppm, preferably from 20 to 1,000 ppm, and more preferably from 40 to 500 ppm. Concentrations lower than these concentrations cause no effects of proline application and, on the other hand, concentrations higher than these concentrations cause growth inhibition.

The fruit-quality improving agent of the present invention can be of course compounded with a wetting agent and, in view of preventing rotting, a bactericide, a surfactant, an antiseptic and the like as long as no adverse effects occur.

The application time of the fruit- and berry-quality improving agent of the present invention onto fruiting plants, in other words, the time of applying the fruit- and berry-quality improving method of the present invention to fruiting plants can be within the period from the mitotic period of flesh cells to the fruit growing period, after flowering. Specifically speaking of pear, peach and apple, the time should start preferably at the period where fruit enlargement begins and fruits reach a size of about table tennis ball. Of grape, it should start preferably at the véraison period, which is a late half period of the fruit growing period. Application of proline provides a preferable effect in the flower-bud period (See “Table 4. Effect on a flower-bud differentiation rate” given later on) and, thus, the effective application thereof is preferably started at the flower-bud forming period or before. Therefore, it is ideal that the proline application is started at the flower-bud forming period or before and continued continuously and intermittently through the subsequent fruit growing period.

The preferable method of proline application is the foliar application onto the leaf surfaces (spraying an aqueous solution) for the purpose of preventing decomposition of the proline by soil microorganisms, and, the leaf surfaces may be either those of the right side or those of the reverse side. But the leaf surfaces of the reverse side can be conceived as preferable for absorption of the proline. By the way, the “spraying onto the leaf surfaces” in the sense used hereby includes not only literally spraying onto the leaf surfaces (sensu stricto), but also proper spraying onto the above-ground parts, including fruits and berries other than leaves (sensu lata).

The spraying amount (applying amount) of the fruit- and berry-quality improving agent of the present invention is, in short, the amount allowing the quality improvement of fruits or berries to be better achieved in comparison with the case of non-spraying. Such amount can be, for example, as could be known from the Test example(s) given later in such degree that the aqueous solution of the fruit- and berry-quality improving agent drops down from the leaf surfaces.

Finally, the form in which the fruit- and berry-quality improving agent of the present invention is put in commercial distribution, will be described, as follows. The fruit- and berry-quality improving agent of the present invention is applied at a concentration range from 15 to 1,500 ppm in terms of the proline as described above. Needless to say, the improving agent can be distributed in the form of a concentrate which can be allowed to provide such a concentration through dilution. Consequently, such a concentrate is naturally falls within the scope of the present invention.

### BEST MODE FOR CARRYING OUT THE INVENTION

Below will be described the invention in detail with reference to Test examples.

### TEST EXAMPLE 1

### Japanese Pear “Kousui”

In this test, proline (L-proline) with a purity of as high as 99% was sprayed on the leaf surfaces of adult trees of Japanese pear “Kousui” for the purpose of examining the effects on the ripening and the quality of fruits and berries. In this test, by using “Kousui” trees in the cultivation field of an enthusiastic farmer having an advanced cultivation technique, any physiological investigation such as the mechanism, kinetics and the like, of the proline application was not carried out, but the influences of the proline (amino acid) applied exogenously was examined, with the attention having been drawn to the quality improvement and progress of ripening of the fruits of the Japanese pear and also the flower bud differentiation related to the results of the next year.

In greater detail, 3 adult Japanese pear trees (cultivar “Kousui”) cultivated in an alluvial soil field managed by the enthusiastic farmer in Ibaraki prefecture, Japan were selected as the target plant. When the 3 adult Japanese pear trees flowered, fruited, and started fruit growth, the following proline spraying test was conducted.

Proline with a purity of 99% was dissolved in water in such amount that the concentration would be 200 ppm (2 g/10 L.) To this solution was added 10 mL of “ATLOX BI” (wetting agent) to prepare an aqueous proline solution. The aqueous proline solution was sprayed all over the surfaces of a half number of the branch leaves, i.e., the leaves on the branches (main branch unit) of each tree of the 3 adult Japanese pear trees to be allowed to drop down from the leaves on June 6 of a year, July 18 of the same year and August 9 of the same year. After the aqueous proline solution was sprayed, examination was carried out regarding a degree of ripening (size of fruit), sugar concentration, and the flower bud differentiation rate. The other half of each tree not sprayed with the aqueous proline solution was used as the control section.

Fruits which had reached a degree of ripening sufficient to be put on the market were gradually harvested, the number of harvest was counted on the harvest day, and the class distribution (for size) was recorded as the degree of ripening. The size of the harvested pears was classified into large (L), medium (M), and small (S), and the large (L) was further classified into 5 classes to assign the largest size to 5L and serially, 4L, 3L, and 2L were assigned, and finally, the smallest size was assigned simply to L. The results recorded will be presented in the following Table 1.

TABLE 1
Harvested number of pears
for different classes (different sizes)

| | Harvest day | | | | | | | |
|---|---|---|---|---|---|---|---|---|
| | August 18 | | August 21 | | August 24 | | Total | |
| | Treated | Control | Treated | Control | Treated | Control | Treated | Control |
| Fruit size | section | Section | section | Section | section | Section | section | Section |
| 5L | 0 | 0 | 4 | 2 | 27 | 3 | 31 | 5 |
| 4L | 25 | 12 | 32 | 12 | 103 | 27 | 160 | 51 |
| 3L | 46 | 14 | 64 | 51 | 123 | 87 | 233 | 152 |
| 2L | 33 | 16 | 46 | 48 | 36 | 34 | 115 | 98 |
| L | 19 | 18 | 18 | 12 | 18 | 3 | 55 | 33 |
| M | 0 | 6 | 11 | 7 | 9 | 3 | 20 | 16 |
| S | 7 | 0 | 10 | 0 | 7 | 1 | 24 | 1 |
| Total | 130 | 66 | 185 | 132 | 323 | 158 | 638 | 356 |

As shown in Table 1, fruits ripened earlier as a tendency in the proline-treated section on the basis of the fruit number for every harvest day. From the fruit size class distribution for every harvest day, it can be seen that any harvest day revealed the larger size of fruits and the larger harvest number for the proline-treated section.

Regarding the sugar concentration of fruits, the sugar content (Brix) of the fruits harvested on August 24 of the year. The content of the individual sugar species was measured by selecting 10 fruits from each section to obtain fruit juices prepared by pressing the fruits, filtering each juice with a membrane filter having a 0.45 μm diameter, and then, quantifying the sugar content for every sugar species by HPLC (Column: “Shim-pack SCR-101C”, Column temperature: 80° C., Solvent: water (1 mL/min); and Detector: RI). The results will be presented in the following Tables 2 and 3.

TABLE 2
Comparison of sugar contents regarding
the fruits harvested on August 24

| Section | Sugar content (Brix) |
|---|---|
| Treated | 11.7 ± 0.1 |
| section | |
| Control | 11.3 ± 0.1 |
| section | |

Regarding the fruits harvested on August 24, the proline-treated section was excellent in the fruit sugar content (Brix), showed a somewhat red pericarp and the tendency of hastened ripening as mentioned before.

TABLE 3
Difference in individual sugar contents
in the fruits (harvested on August 24)

| Section | Fructose | Glucose | Sorbitol | Sucrose | Total |
|---|---|---|---|---|---|
| Treated | 56.74 | 18.67 | 28.83 | 62.09 | 166.12 |
| section | | | | | |
| Control | 51.90 | 16.72 | 22.25 | 49.62 | 140.39 |
| section | | | | | |

Unit: mg/mL
(n = 10)

The excellent fruit sugar concentration could be guessed from the fact that among the analyzed contents for the individual sugar species contained in the fruits, which are presented in Table 3, the sorbitol content was apparently higher for the treated section. Sorbitol is known as a translocated sugar for rosacean plants such as Japanese pear. It is interesting that this sugar species showed a difference between the treated section and the control section.

The flower bud differentiation rate was surveyed by observing winter buds with the unaided eye for each of long fruiting branches and short fruiting branches for every section on February 5 of the next year. The flower bud differentiation rate was calculated as a proportion of the flower bud number (mixed flower buds) to the total winter bud number, provided that the last-year branch was regarded as 1 unit, to which branch a long fruiting branch or a short fruiting branch attached. The results will be presented in the following Table 4.

TABLE 4
Influence on the flower bud differentiation
rate (observed on February 5)

| | Test | | | |
|---|---|---|---|---|
| | section | Tree No. 1 | Tree No. 2 | Total |
| long | Treated | 40.60% | 39.05% | 39.83% |
| fruiting | section | | | |
| branch | Control | 31.98% | 28.19% | 30.08% |
| | section | | | |
| short | Treated | 40.83% | 37.93% | 39.38% |
| fruiting | section | | | |
| branch | Control | 37.83% | 36.79% | 37.31% |
| | section | | | |

As is shown in Table 4, it has been confirmed that, regarding the flower bud differentiation rate, it was apparently enhanced on the long fruiting branch.

Incidentally, for the Japanese pear cultivars “Kousui” and “Housui,” a cultivation technique of fruiting by using long fruiting branches has been popularized, resulting in a stable production. However, in recent years, failure of flower bud formation was reported particularly for “Kousui.” As a measure for this problem, in consideration of the nutrient absorbing system of the “Kousui” tree, balanced fertilizing cultivation management was proposed to avoid an application at a time, of an abundant nitrogen fertilizer. However, nutrient regulation for fruiting trees as perennial plants is difficult, and if nutrient regulation becomes possible by spraying onto leaf surfaces according to the present invention, as described above, this can be a very advanced cultivation technique.

Incidentally, the result of a taste sensory test of the sprayed product (product by the present invention) and the non-sprayed product (the control product) by employing a panel of 40 persons will be shown in Table 5. In this connection, the scores of the sprayed product shown in Table 5 were counted by the following way. I.e., this was carried out in a paired comparison method where the “non-sprayed product” was assigned to Score 0 (control), and the “sprayed product” was scored by 7-class evaluation consisting of Scores +3, +2, +1, 0, −1, −2, and −3, employing a plurality of panels. Next, average values of the results of scoring the “sprayed product” by the plurality of panels were calculated and the average values were assigned to the Scores of the “sprayed product” in Table 5. Hence, the values in Table 5 are the result of scoring the “sprayed product” as a distance from the “non-sprayed product”.

TABLE 5
“Sprayed product” vs “Non-sprayed product”
(results of simple summation)

| | Product with |
|---|---|
| Evaluation Items | spraying |
| Apparent color | 0.06 |
| Strength of whole aroma | 0.26 |
| Preferableness of whole aroma | 0.64 |
| Unripe flavor | −0.41 |
| Strength of whole flavor | 0.57 |
| Preferableness of whole flavor | 0.50 |
| Hardness | −0.13 |
| Juiciness | 0.02 |
| Tongue feeling | −0.19 |
| Preferableness of whole feeling | 0.31 |
| upon eating | |
| Strength of sweetness | 0.95 |
| Preferableness of sweetness | 0.43 |
| Strength of sourness | −0.19 |
| Preferableness of sourness | −0.06 |
| Strength of whole taste | 0.79 |
| Preferableness of whole taste | 0.61 |
| Comprehensive evaluation | 0.74 |

*Score of the “sprayed product” when the “non-sprayed product” is assigned to Score 0 (average Score).

From the results of Table 5 described above, according to the present invention, it can be understood that not only fruits become the larger size, but also other quality factors such as aroma, flavor, feeling upon eating, sweetness, taste and the like become excellent.

It has become clear that sprayed proline brings the effect of influencing the quality of fruits and the nutrient regulation of trees, as described above. So far, any drug damage caused by spraying has not been observed, and therefore, can be evaluated as an effective technique for cultivation of Japanese pear “Kousui”.

### TEST EXAMPLE 2

### Grape

Also in this test example similar to Test example 1, proline (L-proline) with a high purity was sprayed on the leaf surfaces of the adult grape tree to test the effect of influencing the fruit quality. The aqueous proline solution, which had been prepared by dissolving the high purity proline as described above into water to provide a 200 ppm concentration and adding 10 mL of “ATLOX BI” (wetting agent) thereto, was sprayed on the adult grape tree (cultivar Cabernet sauvignon) with an interval of 15 days during the period from the end of June to the middle of September in a year, which is the véraison period as the fruit growing period.

The sprayed amount was a certain amount to allow the solution to drop down from the leaf surfaces. The control section was assigned to another non-sprayed adult tree. Both the test section and the control section were harvested on October 25 in that year to analyze sweetness and a red-colored state. Sweetness was evaluated in terms of the sugar content (Brix) of a juice prepared by mixing and pulverizing seed-removed fruits and pericarps. Colored state (red) was evaluated by measuring a light absorbance of the juice at 522 nm.

The results will be presented in the following Table 6. As shown in Table 6, the proline-sprayed section showed a higher sugar content and a higher colored degree in comparison with the control section.

TABLE 6
Effect of proline application on grape

| | Sugar content | Colored degree |
|---|---|---|
| Section | (Brix) | (OD at 522 nm) |
| Treated | 20.3 | 0.14 |
| Section | | |
| Control | 19.3 | 0.12 |
| Section | | |

According to the market evaluation for a grape cultivar for red wine and a red grape cultivar such as Kyohou, the stronger the coloration (red) of the pericarp is, the better the quality is. Proline-spraying strengthens the red color of fruits and pericarps to show quality improvements. Further, when the content of anthocyanin contained in the juice as described above was analyzed, it was revealed that an about 20% increment in the proline-sprayed section was measured. No difference in the size of fruits was observed between the proline-sprayed section and the control section.

### INDUSTRIAL APPLICABILITY

The qualities of fruits and berries can be improved by applying proline to fruiting plants within the fruit or berry growing period or before. Enhancement of growth of fruits or berries is one of the accompaning effects thereof.

1: A fruit- or berry-quality improving agent containing proline as the effective ingredient, which agent is in the form of an aqueous solution of proline with a 50% or higher purity and having a concentration ranging from 15 to 1,500 ppm in terms of the proline.

2: A fruit- or berry-quality improving agent containing proline with a 50% or higher purity as the effective ingredient, which agent is to be applied after diluted to a concentration ranging from 15 to 1,500 ppm in terms of the proline.

3: A method of improving fruits or berries in quality which method comprises spraying an aqueous solution of proline with a 50% or higher purity and having a concentration ranging from 15 to 1,500 ppm in terms of the proline onto the leaf surfaces of a fruiting plant at the fruit or berry growing period.

4: A method of improving fruit or berries in quality which method comprises spraying an aqueous solution of proline with a 50% or higher purity and having a concentration ranging from 15 to 1,500 ppm in terms of the proline onto the leaf surfaces of a fruiting plant at the fruit or berry growing period or over the period between the flower-bud formation period or before and the fruit or berry growing period.

5: The method of improving fruits in quality of claim 3, wherein said fruiting plant is a plant of Rosaceae or Vitaceae.

6: The method of improving fruits in quality of claim 4, wherein said fruiting plant is a plant of Rosaceae or Vitaceae.
